(19) United States
(12) Patent Application Publication
(10) Pub. No.: US 2007/0016452 A1
(43) Pub. Date: Jan. 18, 2007

(54) Method, software and device for managing patient medical records in a universal format using USB flash drive and radio telephone auto dialer and siren

(76) Inventor: James Bennis Wilson III, Cleveland, OH (US)

Correspondence Address: Squire, Sanders & Dempsey L.L.P.;Two Renaissance Squire, Suite 2700, 40 North Central Avenue, Phoenix, AZ, 85004-4498, US

(21) Appl. No.: 11/450,151

(22) Filed: Jun. 8, 2006

Related U.S. Application Data
(60) Provisional application No. 60/688,906, filed on Jun. 8, 2005.

(51) Int. Cl. G06F 19/00

(52) U.S. Cl. 705/3

(57) ABSTRACT

A method for managing patient medical records in a Universal Format using a USB Flash Drive including the steps of installing a bridge/translation program on a primary care physicians computer system, wherein the bridge/translation program maps the primary care physician's Electronic Medical Record and/or Practice Management Systems patient database records, selecting a patient's records from the Electronic Medical Record and/or Practice Management Systems patient database records to be transferred to a USB Flash Drive, transferring the selected patient's record along with an HTML index page/emergency page to the USB Flash Drive, and when the transfer is complete, providing the USB Flash Drive to the patient, wherein the USB Flash Drive can be used by the patient to print, view and make comments that can be reviewed by the patients primary care physician and inserted into the patients permanent record upon the patient's next visit.

### CROSS REFERENCE TO RELATED APPLICATIONS

This application claims the benefit of U.S. Provisional Application No. 60/688,906, filed Jun. 8, 2005, the contents of which are incorporated herein by reference.

### DESCRIPTION OF THE INVENTION

1. Field of the Invention

The present invention broadly relates to the field of electronic medical record management services. More particularly, the present invention relates to a system and method for creating, storing, accessing, and distributing focused patient medical records. Also, the system will allow the person to contact someone in the case of an emergency by simply pushing a button on the UPRIS Key device.

2. Background of the Invention

In the medical industry, the patient record is the main tool for diagnosing a patient's encounters with their primary care physician. Each encounter is documented in a paper chart and/or a Practice Management System (PMS). In some cases, the encounters are documented in an Electronic Medical Record System (EMR). The EMR system allows the primary care physician to eliminate paper charts and to electronically document most, if not all, patient diagnostic and demographic information of the patients encounter.

Due to the introduction of the Health Insurance Portability and Accountability Act of 1996, patient information is standardizing to allow portability among insurance payers and health care providers. With this portability, privacy and security is a major concern.

This act allows the patient to have ownership of his/or her patient record and have a updated copy of this information given to them any time the patient request the information from his/or her primary care physician. HIPAA allows the patient to request a copy of his/or her patient information, but the patient does not have the right to change information within the patient's records. If there is a question in regards to information within the record, the patient can request comments to be added to the medical record.

When the patient requests a copy of his/or her medical record, it is in big debate who should pay for the cost of photocopying the records. In some cases, the primary care physician charges the patient a fee for receiving a photocopy of their medical record.

Another area of concern is in the repetition of inputting medical information at another medical facility. As HIPAA matures, the portability of medical information will try and eliminate this problem, but as of now, this situation is a major inconvenience for the patient and provider.

There has been a rise in centralized medical records repositories in recent years. This is a sound option for some, however, it still raises several questions of security and ownership of a patients medical records. With HIPAA, the patient does not have the right to alter or change his or/her medical record without the guidance of a trained medical advisor. In addition to the security concerns, the centralized approach relies heavily on high speed Internet access. In most cases, several Internet users are choosing to use 56 k dial-up access due to the high cost of high-speed Internet access.

In some cases, smart card technology has been introduced to store medical records. This is also a sound option for some, but several concerns of extra equipment purchase, high cost of media, and the lack of a standard has made this option limited.

### SUMMARY OF THE INVENTION

The present invention, referred to herein as Universal Patient Record Information System™ or UPRIS™, is a method and system for creating, storing, and distributing patient medical records to a patient, under the control of a patient's primary care physician. The patient will have the capability to add comments that the primary care provider will review and insert in the patients permanent medical record located in the primary care physicians Electronic Medical Record and/or Practice Management system.

This invention does not need major equipment or fabricated parts. Instead, this invention can allow the primary care physician to have a cost effective solution to provide his/or her patient an updated copy of their medical records for review, print and comment. This is accomplished by utilizing standard equipment such as USB (Universal Serial Bus) architecture. This architecture is located on most, if not all, of the computer systems sold to the public. This architecture is standard across many operating systems such as Microsoft™, Unix, Linux, Mac OS™, etc. This allows for the UPRIS system to be utilized in a wide variety of markets and software medical systems.

In most cases, the primary care physician maintains the patient medical record on his/or her Practice Management and/or Electronic Medical Records System. This invention will allow the primary care physician to give an updated copy of his for her patient's medical information for storage, review (by the patient and/or medical advisor) and recover from a disaster at the primary care physicians Practice Management and/or Electronic Medical Records System. A direct communication link can be established with the patient and primary care physician via comments fields the patient and primary care physician can input in the UPRIS system and reviewed by the primary care physician and added to the patient's permanent medical record.

In the case of an emergency, an emergency room staff member or EMS personnel can display the patient's emergency information. This will aid in the critical diagnosis period that could save the patient's life. The emergency personnel would simply put the USB Flash Drive in a computer system with a USB type 2.0 port and point a standard HTML browser to view the patient's emergency demographic information but not be allowed to view the complete patient demographic information without the patient's consent.

If additional information is needed via an established Hospital, Clinic or other health care service provider, then the emergency HTML document will have the contact number of the patient's primary care physician. When the health care service provider contacts the patient's primary care physician, then HIPAA privacy and Security Policies will be enforced to ensure the privacy of the patient's information. After HIPAA Privacy and Security Policies have been established, the primary care physician can send the patient's medical information via HL7 protocol standard utilizing the UPRIS bridge/translator program and a communication media (encrypted Internet connection, secure e-mail, etc.). If the patient is aware of the need for information, then he/or she can grant access to the UPRIS patient record located on the USB Flash Drive, and the Hospital, Clinic or health care service provider can simply go the ANSI 837 text file section and cut-past the file contents to a text file and import the information utilizing HL7 import protocol or a ANSI 837 file interpreter.

If the primary care physician's Practice Management and/or Electronic Medical Record system does not have the capability to send or export information via HL7, then the UPRIS system can be modified to bridge/translate the file information for a nominal fee to the primary care physician. This will be an added bonus to the physician because most laboratory and hospital systems support HL7 transport protocols.

Accordingly, an object of the present invention is to provide a convenient, efficient medical data acquisition, management storage, and retrieval network.

Another object of the present invention is to create a network of participating primary care physicians, dental and other health care service providers.

Another object of the present invention is to give health consumers more control over their own medical care and uphold the standards of HIPAA.

Another object of the present invention is to provide access to a patient's medial demographic information when traveling, who have or are susceptible to chronic illnesses, and who need to have access to key medical data

Another object of the present invention is to provide a backup copy of his/or her patient medical demographic information. In many cases were natural and/or man made disasters, patient medical information is lost forever. With this invention, the patient's medical demographic information can be salvaged and imported into the same primary care physicians Practice Management and/or Electronic Medical Record system.

Another object of the present invention is to enhance the relationships between each patient and his/her primary care physician(s), by allowing them to work together to keep the critical information necessary for optimum medical care current and accessible improving the quality, accuracy, and efficiency of a health care system.

Another object of the present invention is to empower patients, permitting them to become more knowledgeable health care consumers and to better control their health care by allowing them to have direct import into their medical demographic information.

Another object of the present invention is to conserve the Earth's natural resources by reducing and/or eliminating the need for heavy paper consumption

It is to be understood that the descriptions of this invention herein are exemplary and explanatory only and are not restrictive of the invention as claimed.

### BRIEF DESCRIPTION OF THE DRAWINGS

FIG. 1 is an overview of the UPRIS system.

FIG. 2 shows data connections of the UPRIS system.

FIG. 3 shows the USB Flash Drive of the UPRIS system.

FIG. 4 shows the radio transmitter feature of the UPRIS system.

FIG. 5 shows an additional view of the USB Flash Drive of the UPRIS system.

### DESCRIPTION OF THE EMBODIMENTS

Reference will now be made in detail to the present exemplary embodiments of the invention, examples of which are illustrated in the accompanying drawings.

The present invention provides a method, software and device for managing patient medical records in a Universal Format using a USB Flash Drive that supports the creation, storing, accessing, updating, and distributing of patient medical records from the patient's primary care physician Electronic Medical Records system and/or the primary care physicians practice management system and has a Telephone Autodialer to contact emergency agencies in the case of personal injury. The system has four (4) major components (not including the primary care computer system, patient computer system and/or a third-party computer system) that the UPRIS (Universal Patient Record Information System) comprises from. The first component is a software program that resides on the primary care physicians computer system that extracts the patients record in an encrypted (using 128 bit triple des encryption) and compressed read-only format that can only be read by the UPRIS translator program located on a USB Flash Drive that has a radio transmitter to signal the base unit of the UPRIS Telephone and siren receiver. The Second component is a USB (universal serial bus) Flash Drive that the primary care physicians Electronic Medical Records and/or Practice Management computer system can interface with using the standard USB 2.0 port found on most computer systems. The Third component is the UPRIS patient management file system located on the USB Flash Drive. The forth component is a telephone auto dialer radio signal receiver that receives a signal from the UPRIS flash drive and dials an emergency agency and initiates a siren to send emergency personal to proper location. The UPRIS System can store the patient's complete demographic information including name, address, insurance information and also clinical data such as shot records, lab results and x-rays

The present invention utilizes standard USB (Universal Serial Bus) architecture to store and distribute patient medical demographic and diagnostic information. This description of a system architecture and a method for implementing a medical record management system within that architecture are examples of preferred embodiments of the present invention. While the method described herein and illustrated in the figures contains many specific examples of information flow steps, these steps should not be construed as limitations on the scope of the invention, but rather as examples of information flow steps that could be used to practice the invention. As would be apparent to one of ordinary skill in the art, many other variations on the system operation are possible, including differently grouped and ordered method steps. Accordingly, the scope of the invention should be determined not by the embodiments illustrated in these examples, but by the appended claims and their equivalents. The radio receiver and transmitter will use the standard frequency allocated by governing communications agencies.

System Architecture

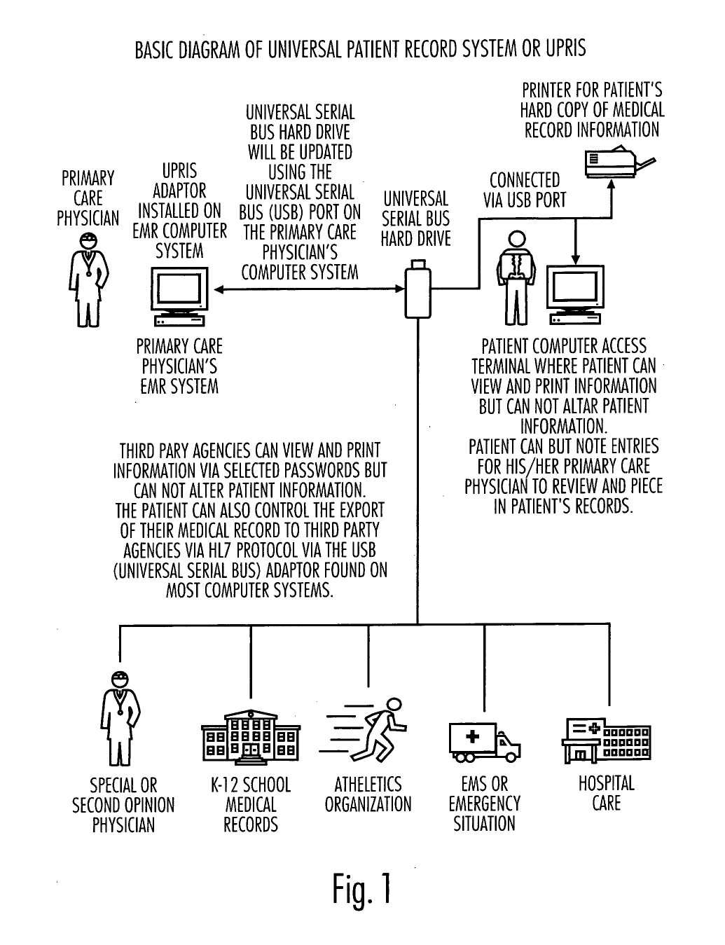

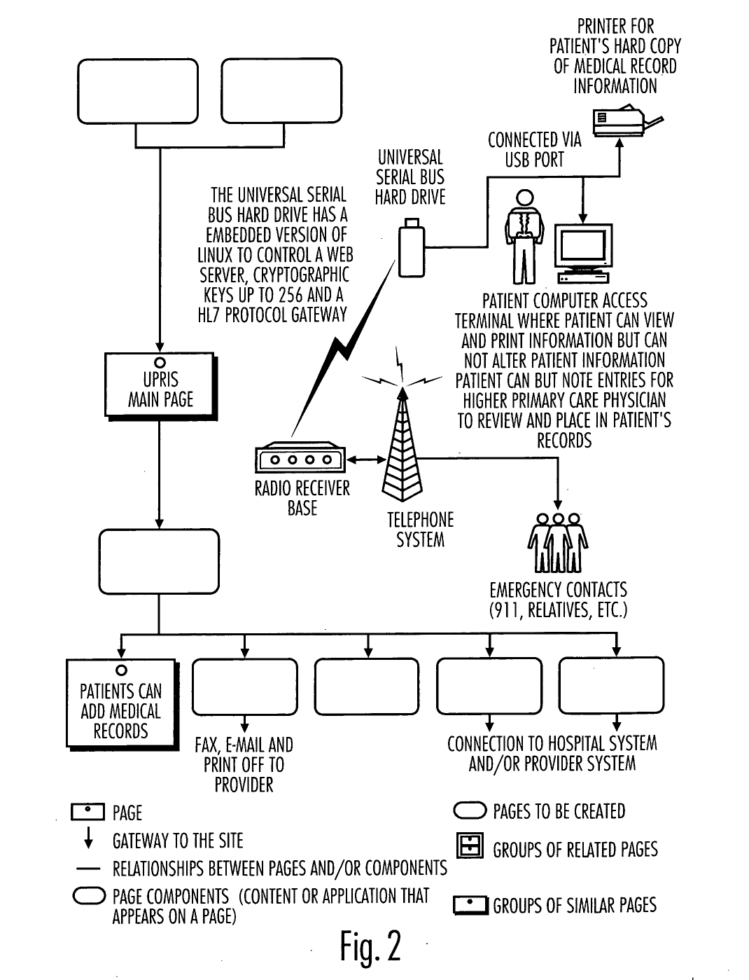

FIG. 1 explains the overall view of the UPRIS system. The primary care physician installs the UPRIS bridge/translation software on his/or her computer system with the Patient Management and/or Electronic Medical Record system. As shown in FIG. 2, the invention will map the Patient Management and/or Electronic Medical Record system's patient demographic database(s). If the primary care physician's Patient Management and/or Electronic Medical Record system does not have a pre-defined database mapping, then program changes may be made to allow the primary care physician's system to be translated and/or bridged with the UPRIS software.

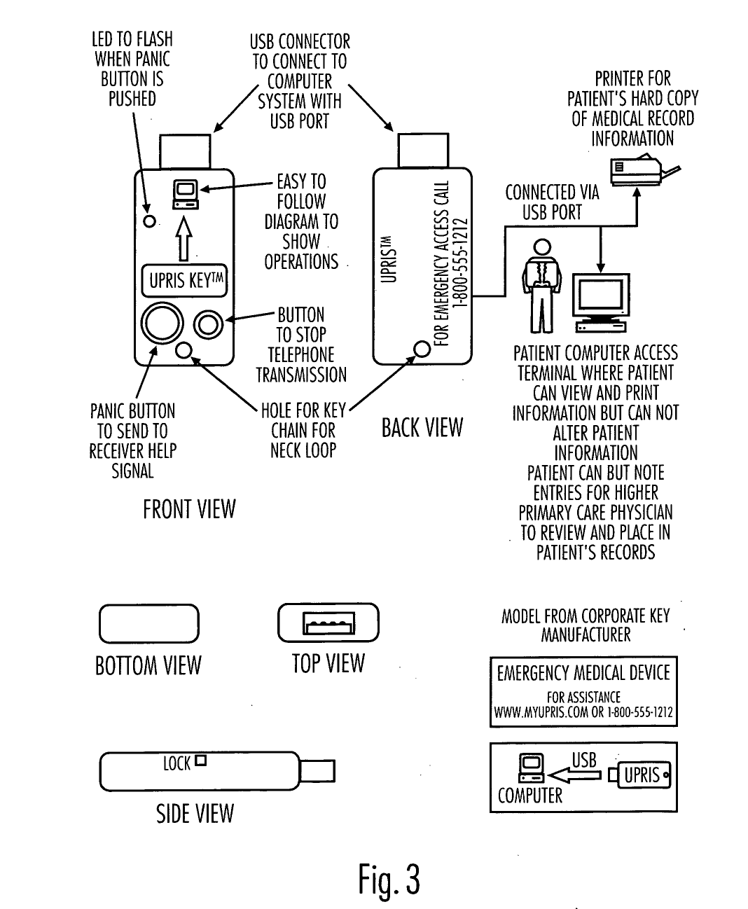

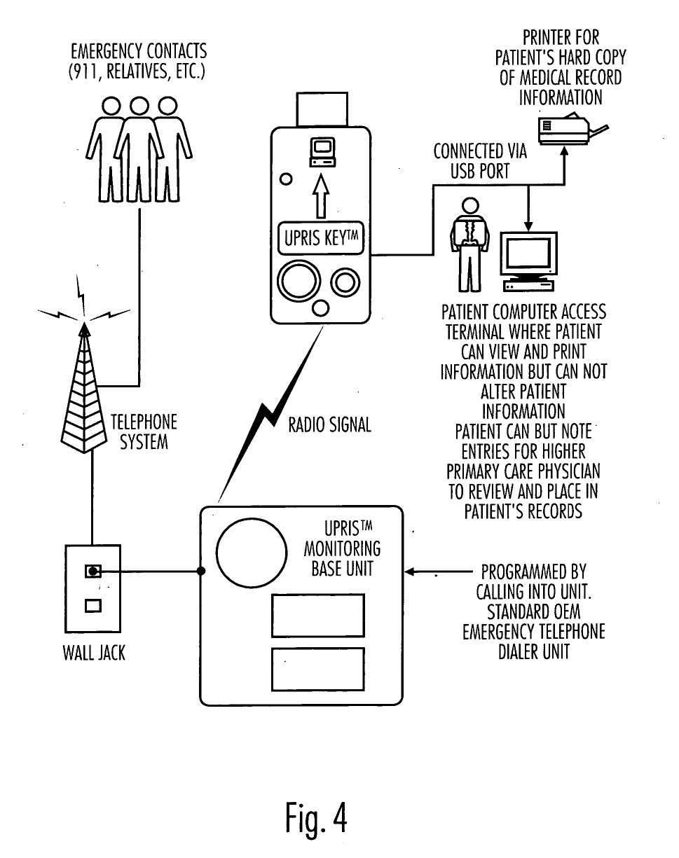

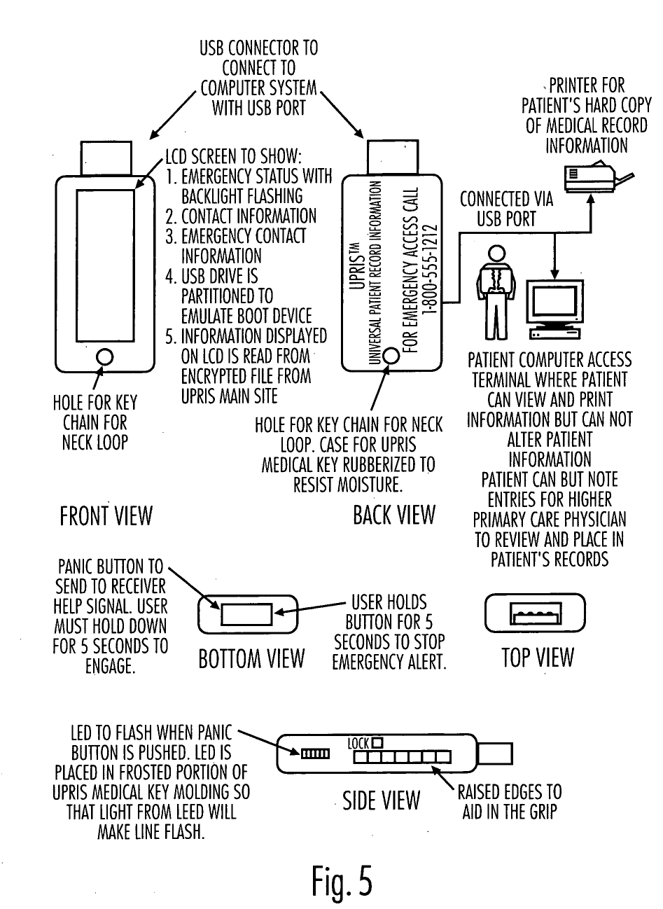

As referred to in FIG. 3, the UPRIS system utilizes a USB Flash Drive to allow the patient's demographic information to be transported with the patient. The patient will access the UPRIS patient record via a PDF™ reader. The patient UPRIS record is displayed in diagram 103(a) with illustrates. FIG. 4 shows the radio transmitter feature of the UPRIS system. FIG. 5 shows an additional view of the USB Flash Drive of the UPRIS system.

A method for managing patient medical records in a Universal Format using a USB Flash Drive may include the following steps: (a) installing a bridge/translation program on the primary care physicians computer system, wherein the UPRIS bridge/translation maps the primary care physicians Electronic Medical Record and/or Practice Management Systems patient database records (b) selecting the patients records to be transferred to a UPRIS USB Flash Drive from the UPRIS bridge/translation software; (c) compressing and encrypting selected patient records utilizing the UPRIS bridge/translation software in a standard read-only format with password protection format capable of producing diagnostic-quality images (this step is optional); (d) transferring the encrypted and compressed selected patient records (however the records need not be encrypted and compressed) along with a HTML index page/emergency page to the USB Flash Drive utilizing the UPRIS bridge/translation software; (e) when the transfer is complete, the USB Flash Drive can be used by the patient to print, view and make comments that can be reviewed by the patients primary care physician and inserted into the patients permanent record upon his/or hers' next visit; upon (f) providing an authorized 3rd party user with limited access to the patient demographics information, the patient can allow others to view, print and make comments to the primary care physician.

Preferably, in the method described above, the physician would pay for the UPRIS bridge/translation software connected to the primary care physicians Electronic Medical Records and/or Practice Management System.

In another embodiment of the above method, the UPRIS bridge/translation software would also allow the primary care physician to connect their Electronic Medical Records and/or Practice Management System to a HL7 compatible system for a universal transfer of data with other clinical record systems in keeping with HIPAA (Health Insurance Portability and Accountability Act of 1996.)

In another embodiment of the above method, the step of bridging/translating the primary care physicians electronically stored records and images would come from an existing database.

In another embodiment of the above method, the standard read-only format would be in a PDF (Adobe (tm) Portable Document) Format. Of course, other data formats could also be used.

In another embodiment of the above method, the step of electronically storing the diagnostic-quality images embeds the images in the PDF file and compressed into a high-resolution format file.

In another embodiment of the above method, the step of providing an authorized user(s) with access comprises the steps of: prompting the authorized user within the PDF file and a graphical interface and authentication methods such as electronic signature and/or programming scripts allowing the authorized user(s) access to the appropriate patient demographic and/or diagnosis information. An HTML index file will be utilized to categorize the appropriate file name and location of the patient's medical information.

In another embodiment of the above method, on the HTML index file, an emergency information page will be available in the case of an emergency and can be easily viewed with a standard HTML browser.

In another embodiment of the above method, the UPRIS system will utilize a USB Flash Hard Drive for portable storage not a flash card, smart card and/or memory stick.

In another embodiment of the above method, the authorized 3rd party user is a physician, a relative of the patient, medical specialist and/or athletic trainer.

In another embodiment of the above method, the steps for encrypting the output in a standard read-only format with password protection format, the UPRIS bridge/translation program will assign passwords and encryption key that the primary care physician will relay to the patient to allow view and/or printing of the patients health information. This will not allow the patient to alter their patient records, but will allow comments to be reviewed and added to the patient permanent records upon revisiting his or her primary care physician.

In another embodiment of the above method, the term primary care physician can be associated with the patient's primary care health physician and/or dental care physician. Both the patient's medical and dental records can be stored on the USB Flash Drive with the addition of patient's minor (under the age of 18 and under the direct supervision of the patient) children.

In another embodiment of the above method, the UPRIS system will place hyperlinks to the associated file for all patient information files located on the USB Flash Hard Drive.

In another embodiment of the above method, it is under the understanding that the images the UPRIS bride/translation software transfers to the USB Flash Hard Drive is originating from the primary care physician's Electronic Medical Records and/or Practice Management System. With this in mind, the images should be of diagnostic quality.

In another embodiment of the above method, the UPRIS key (USB drive) will have a radio transmitter with a safety button when activated (either push button or pull tab) will transmit a radio signal to the receiver base and flash a LED light until reset by emergency personnel or by holder of the UPRIS key.

In another embodiment of the above method, the receiver base would receive the radio-transmitted signal from the UPRIS key and initiate a siren to alert emergency personnel. The system would then dial (pulse or touch tone) a sequence of pre-defined telephone numbers to aid in medical attention. When the caller is connected via the telephone number(s), the called party will be able to listen in and communicate with the person that has the UPRIS Key device until emergency personnel can reach the victim.

Other embodiments of the invention will be apparent to those skilled in the art from consideration of the specification and embodiments disclosed herein. Thus, the specification and examples are exemplary only, with the true scope and spirit of the invention set forth in the following claims and legal equivalents thereof.

What is claimed is:

1. A method for managing patient medical records in a Universal Format using a USB Flash Drive comprising the steps of:
installing a bridge/translation program on a primary care physicians computer system, wherein the bridge/translation program maps the primary care physician's Electronic Medical Record and/or Practice Management Systems patient database records;
selecting a patient's records from the Electronic Medical Record and/or Practice Management Systems patient database records to be transferred to a USB Flash Drive;
transferring the selected patient's record along with an HTML index page/emergency page to the USB Flash Drive; and
when the transfer is complete, providing the USB Flash Drive to the patient, wherein the USB Flash Drive can be used by the patient to print, view and make comments that can be reviewed by the patients primary care physician and inserted into the patients permanent record upon the patient's next visit.

2. The method of claim 1 further including the step of:
compressing and encrypting the selected patient's record into a standard read-only format capable of producing diagnostic-quality images prior to the transferring step.

3. The method of claim 2 wherein the compressed and encrypted patient's record is password protected.

4. The method of claim 1 further including the step of:
providing an authorized 3rd party user with limited access to the selected patient's records.

5. The method of claim 1, wherein the primary care physician would pay for the bridge/translation program

6. The method of claim 1, wherein the bridge/translation program would allows the primary care physician to connect their Electronic Medical Records and/or Practice Management System to a HL7 compatible system for a universal transfer of data with other clinical record systems in keeping with HIPAA (Health Insurance Portability and Accountability Act of 1996.)

7. The method of claim 1, wherein the step of bridging/translating the primary care physicians electronically stored records and images would come from an existing database.

8. The method of claim 2, wherein the standard read-only format is PDF (Adobe (tm) Portable Document) Format.

9. The method of claim 2, wherein the diagnostic-quality images are embedded in a PDF file and compressed into a high-resolution format file.

10. The method of claim 4, wherein the step of providing an authorized 3rd party user( with access comprises the steps of:
prompting the authorized user within the PDF file and a graphical interface and authentication methods such as electronic signature and/or programming scripts allowing the authorized user(s) access to the appropriate patient demographic and/or diagnosis information.

11. The method of claim 1, wherein, on the HTML index file, an emergency information page will be available in the case of an emergency and can be easily viewed with a standard HTML browser.

12. The method of claim 4, wherein the authorized 3rd party user is a physician, a relative of the patient, medical specialist, and/or athletic trainer.

13. The method of claim 3, wherein steps for encrypting the selected patient's record in a standard read-only format with password protection format, the bridge/translation program assigns passwords and an encryption key that the primary care physician will relay to the patient to allow view and/or printing of the patients health information.

14. The method of claim 1, wherein the term primary care physician can be associated with the patient's primary care health physician and/or dental care physician.

15. The method of claim 1, wherein hyperlinks are placed in the associated file for all patient's records located on the USB Flash Drive.

16. Te method of claim 1, wherein the USB Flash Drive utilizes a radio transmitter with a safety button when activated (either push button or pull tab) transmit a radio signal to the receiver base and flash a LED light until reset by emergency personnel or by holder of the USB Flash Drive.

17. The method of claim 19, wherein a receiver base would receives the radio-transmitted signal from the USB Flash Drive and initiates a siren to alert emergency personnel.
